(19) United States
(12) Patent Application Publication
(10) Pub. No.: US 2025/0380120 A1
(43) Pub. Date: Dec. 11, 2025

(54) EMERGENCY INCIDENT DETECTION USING MULTIPLE DEVICES AND DIFFERENTIAL ALERTING TO NEARBY DEVICES

(71) Applicant: Samsung Electronics Co., Ltd., Suwon-si (KR)

(72) Inventors: Yuanyuan Song, Jersey City, NJ (US); Ha Jin Choi, Springfield, NJ (US); Myoung Woo Nam, Yongin-si (KR); Mi Yeoung Chung, Seoul (KR); Amarvikash Vigneswaran, Hillsboro, OR (US)

(21) Appl. No.: 18/740,329

(22) Filed: Jun. 11, 2024

(51) Int. Cl. H04W 4/90; G08B 7/06; H04W 4/029

(52) U.S. Cl. CPC H04W 4/90; G08B 7/06; H04W 4/029

(57) ABSTRACT

A method includes receiving signals from a plurality of electronic devices, each signal corresponding to at least one of various types of sensed input from the electronic devices indicating an emergency incident. A plurality of different zones, possibly more than two, is assigned relative to the emergency incident. The method includes providing a first type of alert regarding the emergency incident to a first electronic device of the plurality of electronic devices located within a first zone of the plurality of different zones. In addition, the method includes providing a second type of alert regarding the emergency incident to a second electronic device of the plurality of electronic devices located within a second zone of the plurality of different zones. Locations within the second zone are more distant from the emergency incident than locations within the first zone. The first type of alert differs from the second type of alert.

### TECHNICAL FIELD

This disclosure relates generally to providing alerts for emergency situations. More specifically, this disclosure relates to emergency incident detection using multiple devices and differential alerting to nearby devices.

### BACKGROUND

When there is an extreme emergency situation, such as a mass shooting, affected individuals cannot be identified and notified quickly enough and often will not understand what to do to protect themselves. Furthermore, even though the affected individuals are experiencing the same incident, different individuals will often have different priorities of actions depending on their physical locations (such as proximity). For example, the most important task for individuals very close to a mass shooter may be to shelter and hide quietly or to run. By contrast, individuals not as close to the shooter may be capable of informing first-responders or safely monitoring their surroundings.

### SUMMARY

This disclosure relates to emergency incident detection using multiple devices and differential alerting to nearby devices.

In a first embodiment, a method includes receiving signals from a plurality of electronic devices. Each signal corresponds to a sensed input at one of the plurality of electronic devices that indicates an emergency incident, examples of which include (but are not limited to) a gunshot sound or screaming, optionally in combination with rapid movement of the electronic device suggesting running or falling. The method also includes assigning a plurality of different zones relative to the emergency incident. The method further includes providing a first type of alert regarding the emergency incident to a first electronic device of the plurality of electronic devices located within a first zone of the plurality of different zones. The different zones include at least first and second zones, and optionally may include a third zone, a fourth zone, etc. In addition, the method includes providing a second type of alert regarding the emergency incident to a second electronic device of the plurality of electronic devices located within a second zone of the plurality of different zones. Locations within the second zone are more distant from the emergency incident than locations within the first zone. The first type of alert differs from the second type of alert. Each type of alert may be different depending on the situation, and the type of alert provides users the most urgent information with suitable settings.

In a second embodiment, an electronic device includes at least one processing device configured to receive signals from a plurality of electronic devices. Each signal corresponds to a sensed input at one of the plurality of electronic devices that indicates an emergency incident. The at least one processing device is also configured to assign a plurality of different zones relative to the emergency incident. The different zones include at least first and second zones, and optionally may include a third zone, a fourth zone, etc. The electronic device also includes a transceiver configured to provide a first type of alert regarding the emergency incident to a first electronic device of the plurality of electronic devices located within a first zone of the plurality of different zones and to provide a second type of alert regarding the emergency incident to a second electronic device of the plurality of electronic devices located within a second zone of the plurality of different zones. Locations within the second zone are more distant from the emergency incident than locations within the first zone. The first type of alert differs from the second type of alert. Each type of alert may be different depending on the situation, and the type of alert provides users the most urgent information with suitable settings.

In a third embodiment, a non-transitory machine readable medium contains instructions that when executed cause at least one processor of an electronic device to receive signals from a plurality of electronic devices. Each signal corresponds to a sensed input at one of the plurality of electronic devices that indicates an emergency incident. The non-transitory machine readable medium also contains instructions that when executed cause the at least one processor to assign a plurality of different zones relative to the emergency incident. The different zones include at least first and second zones, and optionally may include a third zone, a fourth zone, etc. The non-transitory machine readable medium further contains instructions that when executed cause the at least one processor to provide a first type of alert regarding the emergency incident to a first electronic device of the plurality of electronic devices located within a first zone of the plurality of different zones. In addition, the non-transitory machine readable medium contains instructions that when executed cause the at least one processor to provide a second type of alert regarding the emergency incident to a second electronic device of the plurality of electronic devices located within a second zone of the plurality of different zones. Locations within the second zone are more distant from the emergency incident than locations within the first zone. The first type of alert differs from the second type of alert. Each type of alert may be different depending on the situation, and the type of alert provides users the most urgent information with suitable settings.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example network configuration including an electronic device employed to detect emergency incidents and provide differential alerts in accordance with this disclosure;

FIG. 2 illustrates an example process for detecting emergency incidents and providing differential alerts in accordance with this disclosure;

FIG. 3 illustrates an example distance-based assignment of zones in accordance with this disclosure;

FIG. 4 illustrates an example dynamic distance-based assignment of zones in accordance with this disclosure;

FIG. 5 illustrates an example alert that may be transmitted to devices and corresponding information that may be provided in accordance with this disclosure;

FIG. 6 illustrates an example of different notifications for different zone assignments in accordance with this disclosure;

FIGS. 7A and 7B illustrate another example process for detecting emergency incidents and providing differential alerts in accordance with this disclosure;

FIG. 8 illustrates another example distance-based assignment of zones in accordance with this disclosure;

FIG. 9 illustrates yet another example distance-based assignment of zones in accordance with this disclosure;

FIG. 10 illustrates an example process for zone assignment for differential alerts depending on terrain in accordance with this disclosure;

FIG. 11 illustrates an example assignment of zones for a heatwave incident in accordance with this disclosure;

FIG. 12 depicts an example of different notifications for different zone assignments with respect to FIG. 11 in accordance with this disclosure; and

FIG. 13 illustrates an example method for emergency incident detection using multiple devices and differential alerting to nearby devices in accordance with this disclosure.

### DETAILED DESCRIPTION

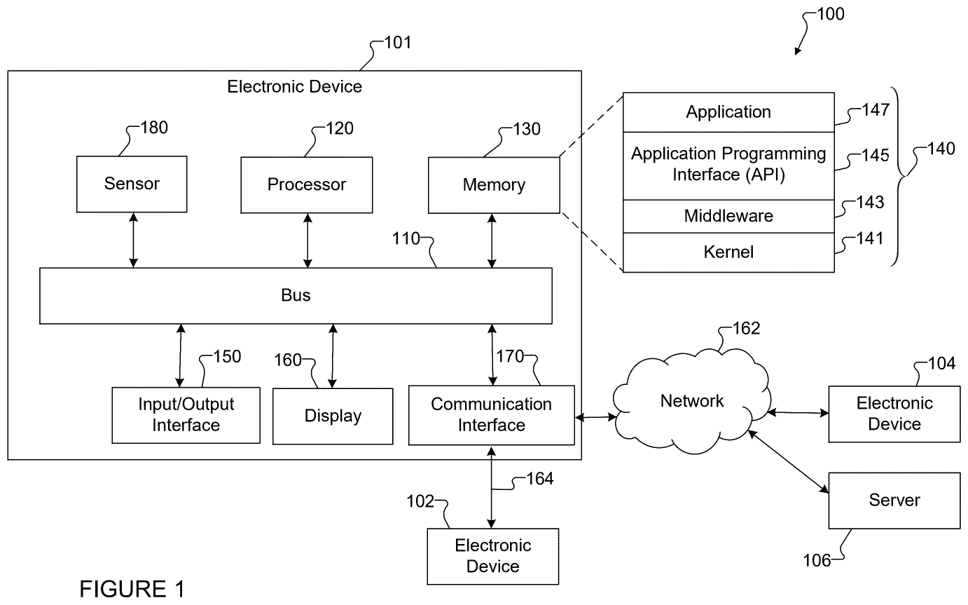

FIGS. 1 through 13, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, when there is an extreme emergency situation, such as a mass shooting, affected individuals cannot be identified and notified quickly enough and often will not understand what to do to protect themselves. Furthermore, even though the affected individuals are experiencing the same incident, different individuals will often have different priorities of actions depending on their physical locations (such as proximity). For example, the most important task for individuals very close to a mass shooter may be to shelter and hide quietly or to run. By contrast, individuals not as close to the shooter may be capable of informing first-responders or safely monitoring their surroundings.

This disclosure provides various techniques supporting emergency incident detection using multiple devices and differential alerting to nearby devices. As described in more detail below, information essential or important to assessing a potential emergency incident can be collected via electronic devices near the site in order to identify the situation. Once the incident is identified, individuals based on physical locations are identified, and appropriate alerts (such as those with different sound/haptic/content combinations) are sent to the devices associated with those individuals. As a result, users receive the most proper alert to help the respective user take suitable action(s).

For an emergency situation such as a mass shooting, because device users are facing a potentially life-threatening situation, they need to quickly understand the situation and then act properly. Thus, notifications sent to different user devices should be different depending on their situation. For example, users close to the incident, who may already hear or witness the incident, may need to hide or evacuate without drawing too much attention to themselves. Accordingly, the notification sent to their devices may be short and quiet. Users who might not be within range of an attacker but who are still in a direct life-threatening situation may receive a strong notification because their first action may be evacuating as soon as possible. Users who are not in a direct life-threatening situation may receive a strong notification about the incident status. Users in all zones may receive real-time incident status updates, which can still follow the rules based on their circumstances. Of course, the situations described in this paragraph are merely examples, and variants are described below.

FIG. 1 illustrates an example network configuration 100 including an electronic device employed to detect emergency incidents and provide differential alerts in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), or a graphics processor unit (GPU). The processor 120 is able to perform control on at least one of the other components of the electronic device 101 and/or perform an operation or data processing relating to communication or other functions. As described in more detail below, the processor 120 may perform various operations related to detecting emergency incidents and providing differential alerts. For example, as described below, the processor 120 may identify gunshot sounds, forward device location information, and/or display alerts.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may support various functions related to d detecting emergency incidents and providing differential alerts. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user. Notably, some wearable devices such as a smart ring or earbuds may not have a physical display, but may still output notifications via another medium such as sounds and/or haptics.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, one or more sensors 180 can include one or more cameras or other imaging sensors for capturing images of scenes. The sensor(s) 180 can also include one or more buttons for touch input, one or more microphones, a gesture sensor, a gyroscope or gyro sensor, an air pressure sensor, a magnetic sensor or magnetometer, an acceleration sensor or accelerometer, a grip sensor, a proximity sensor, a color sensor (such as an RGB sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the first external electronic device 102 or the second external electronic device 104 can be a wearable device or an electronic device-mountable wearable device (such as an HMD). When the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network. The electronic device 101 can also be an augmented reality wearable device, such as eyeglasses, which include one or more imaging sensors.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can support the electronic device 101 by performing at least one of operations (or functions) implemented on the electronic device 101. For example, the server 106 can include a processing module or processor that may support the processor 120 implemented in the electronic device 101. As described in more detail below, the server 106 may perform various operations related to detecting emergency incidents and providing differential alerts. For example, as described below, the server 106 may identify an incident location, facilitating confirmation of an emergency situation, and/or transmit notifications. The server 106 may further instruct other devices to perform certain operations (such as capturing audio using an audio input device like a microphone and/or outputting audio using an audio output device like a speaker) or display content on one or more displays 160. In addition, the server 106 may receive inputs (such as public information) and manage reporting to first responders.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

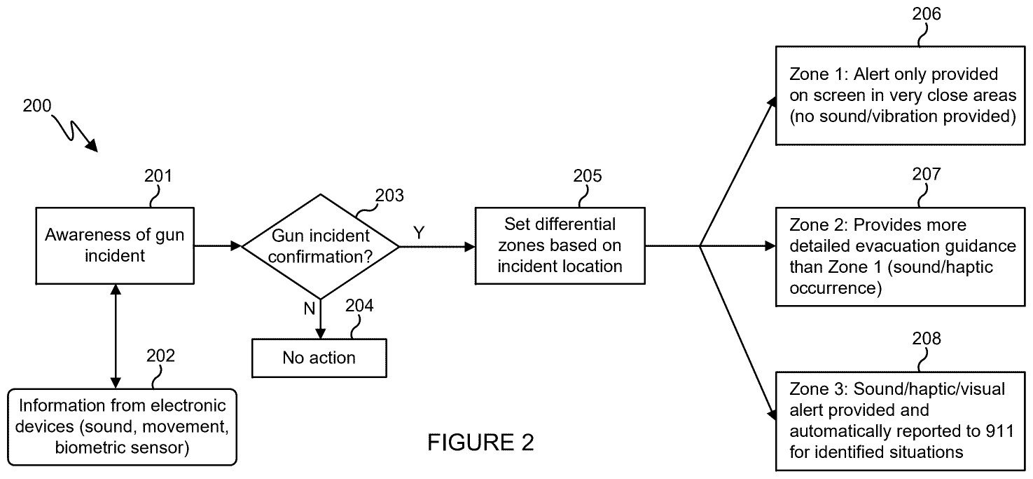

FIG. 2 illustrates an example process 200 for detecting emergency incidents and providing differential alerts in accordance with this disclosure. For case of explanation, the process 200 is described as involving the use of the electronic device 101 in the network configuration 100 of FIG. 1. However, the process 200 may be used with any other suitable electronic device(s), such as the server 106, and in any other suitable system(s).

As shown in FIG. 2, the process 200 includes receiving signals from a plurality of electronic devices from which awareness of a gun incident or other incident (block 201) can be determined. The electronic devices may include smart phones, smart watches, smart rings, and/or earbuds. In some embodiments, various data sets from the smart devices may be collected (block 202). As particular examples, audio (sounds) may be collected from microphones of the electronic devices and processed to identify gunshots, screams, etc. Geo-location data may be collected from GPS receivers of the electronic devices and processed to identify sudden movements, sudden change of elevation, etc. Measurements from accelerometers of electronic devices may also be collected from the electronic devices and processed to identify sudden movements, sudden change of elevation, etc. Biometric data may be collected from biometric sensors in some wearable electronic devices, such as smart watches, smart rings, or ear buds, and processed for heart rate, blood pressure, body temperature, etc. The plurality of electronic devices may each be configured to process the types of inputs described above and transmit signal(s) to the electronic device 101 in the network configuration 100 when one or more inputs meet one or more criteria correlated with gun incidents (such as gunshot sounds) or other types of incidents.

The determination of when criteria correlated with gun incidents or other incidents are met may be confirmed (block 203), such as by utilizing on-device or cloud-based algorithms or artificial intelligence (AI) or machine learning (ML) models with the input(s) to calculate the likelihood of the potential incident actually constituting an emergency situation, such as a gunshot, to further boost the accuracy of incident detection. Other data may also be considered and analyzed in the background when calculating the likelihood of an emergency situation, such as crime rate in the area, public reports, input from a city gunshot detector, a social media algorithm, other public data available from the Internet, etc. If and when the possibility of an emergency situation can be eliminated, no further action is taken (block 204). However, until such time, the process 200 continues to assess the likelihood of an emergency situation being in progress and takes steps to transmit notifications and request manual confirmation as described below.

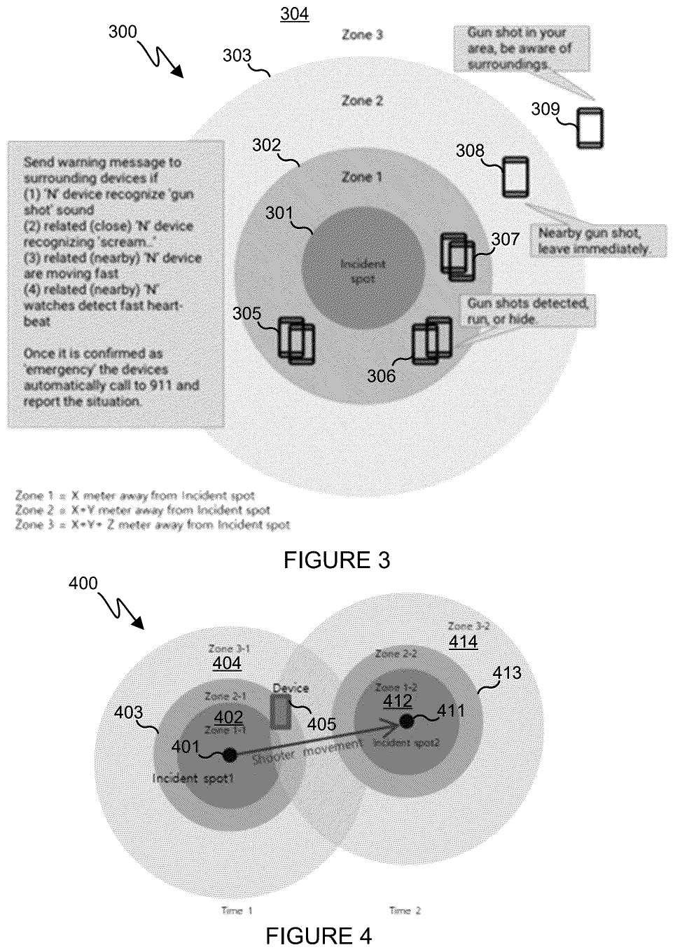

FIG. 3 illustrates an example distance-based assignment 300 of zones in accordance with this disclosure. In this example, an incident is assumed to occur in open space, such as not within a building. Once signals are received from multiple devices (such as three or more devices like devices 305-307 in FIG. 3) that capture a gunshot sound or other incident sounds, the directions and/or distances from each device to an attacker can be calculated (such as by triangulation) so that the incident or attacker's location can be determined. Based on the incident location, the system assigns a plurality of zones (block 205). In the example of FIGS. 2 and 3 being described, three zones (Zone 1 302, Zone 2 303, and Zone 3 304) are defined according to distance from the determined incident location 301.

As shown in FIG. 3, the incident location 301 is identified within a certain range of accuracy and may be treated as either centered within that area or as having a (generally circular) perimeter corresponding to the accuracy of the location. Zone 1 302 is assigned to locations within a distance of X meters away from the incident location 301. Zone 2 303 is assigned to locations within a distance of at least X meters but less than X+Y meters away from the incident location 301. Zone 3 304 is assigned to locations within a distance of at least X+Y meters but less than X+Y+Z meters away from the incident location 301. In the example embodiment, the zones are assigned once the incident location is determined, regardless of whether the existence of an emergency situation has been confirmed.

Throughout confirmation of an emergency situation and for the duration of the incident, when device locations change from one zone to another (such as from Zone 1 302 to Zone 2 303 based on either a change in the incident or attacker's location or the device user's location), devices within the updated Zone 2 303 may also be requested to confirm the incident manually. However, in some embodiments, when an incident has already been confirmed, human confirmation on the shooter's movement may not be necessary if other supporting data is sufficient. FIG. 4 illustrates an example dynamic distance-based assignment 400 of zones in accordance with this disclosure. Analogous to FIG. 3, for an incident location 401 at time 1, a Zone 1 402, a Zone 2 403, and a Zone 3 404 are assigned, such as based on the distances described above.

For an updated incident location 411 at time 2 resulting from movement of the attacker, a new Zone 1 412, a new Zone 2 413, and a new Zone 3 414 are assigned based on the same distances. The location of the attacker can be updated and reflected in real-time as the smart devices keep collecting data, such as gunshot sound and other supporting data. Therefore, information from the devices can be used to generate historical information on attacker movements. As illustrated by FIG. 4, the zone assignments for devices are also updated in real-time based on the changes in incident location. For example, in FIG. 4, when the attacker was identified as being at incident location 401, the device 405 was in initial Zone 2 403. However, as the attacker moved to incident location 411, data continued to be collected and calculations for the attacker location and zones continued to be updated, so the same device 405 may be recategorized as located within updated Zone 3 414.

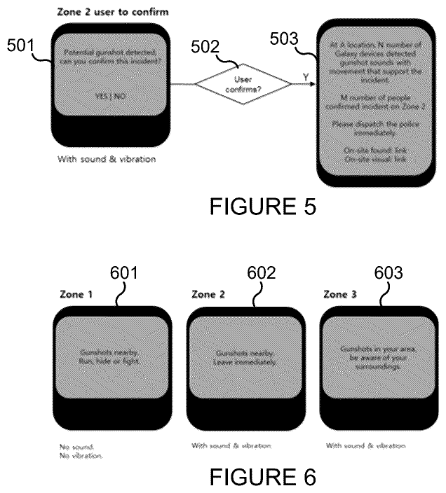

As part of confirming the existence of an emergency situation, if the calculated likelihood (block 203) reaches a threshold (such as 80%), devices within Zone 2 303 can be sent a “strong” notification. A strong notification may represent a push notification that can override silencing of other alerts within the device and may request manual confirmation by the respective device's user of the emergency situation. Zone 2 device users may need to confirm the incident manually, such as by touching a confirmation user interface prompt on the device display (or, for wearable devices not including a display such as smart rings or earbuds, touching a user control to provide confirmation). FIG. 5 illustrates an example alert 501 that may be transmitted to devices and corresponding information that may be provided in accordance with this disclosure. More specifically, the alert 501 may be transmitted to devices (such as device 308) located within Zone 2 303. In the example shown, the alert 501 includes the message “Potential gunshot detected, can you confirm this incident?” and user interface prompts for “Yes” and “No.” If the user confirms the emergency situation (block 502), detailed information 503 may be provided as an incident to emergency services (such as 911). As shown in FIG. 5, the information 503 may include the location (“A”), the number of devices (“N”) that detected gunshot sounds, the number (“M”) of users that confirmed the incident, and links to any audio and/or video feeds available at the incident location 301. The information 503 may be updated as warranted during the incident.

As long as there is one confirmation from a Zone 2 device, the incident can be confirmed. Moreover, if any device in any zone reports an emergency situation using other methods (such as by calling 911), the incident can also be confirmed even in the absence of a confirmation from a Zone 2 device. Data collected by an alternative method of reporting can also be used for sending upcoming notifications. It should be noted that zones may be established based on the 911 call, or possibly based on sounds and/or biometric data collected by the devices.

For a confirmed emergency situation, the zone assignments (block 205) are used to send notifications, examples of which are depicted in FIG. 6. FIG. 6 illustrates an example of different notifications for different zone assignments in accordance with this disclosure. Devices 305, 306, and 307 located within Zone 1 302, in close proximity to the incident location 301, are sent an alert that is only displayed on screen with no sound or haptic output provided. As shown in FIGS. 3 and 6, the alert 601 provided (block 206) to devices 305, 306, and 307 located within Zone 1 302 may read “Gun shots detected, run or hide.” Devices (such as device 308) located within Zone 2 303 are provided more detailed guidance (block 207) than Zone 1 302 in an alert that may include sound or haptic output. As shown in FIGS. 3 and 6, the visual portion of an alert 602 to device 308 located within Zone 2 303 may read “Nearby gun shot, leave immediately.” Devices (such as device 309) located within Zone 3 304 are provided an alert (block 208) that includes visual, sound, and haptic output, and the devices may automatically transmit a report to 911 and/or a notification to the emergency contact for the corresponding device for identified situations. As shown in FIGS. 3 and 6, the visual portion of an alert 603 to device 309 located within Zone 3 304 may read “Gun shot in your area, be aware of surroundings.” It should be noted that, when any of devices 305, 306, 307, 308, or 309 are wearable devices that do not include a display, the differential alerting may occur via another medium (e.g., sounds and/or haptics).

Although FIGS. 2 through 6 illustrate one example of a process 200 for detecting emergency incidents and providing differential alerts and related details, various changes may be made to FIGS. 2 through 6. For example, while shown as a series of steps, various steps in FIG. 2 could overlap, occur in parallel, occur in a different order, or occur any number of times (including zero times). Also, the specific zones and alerts shown in FIGS. 3 through 6 are examples only and can easily vary depending on the circumstances.

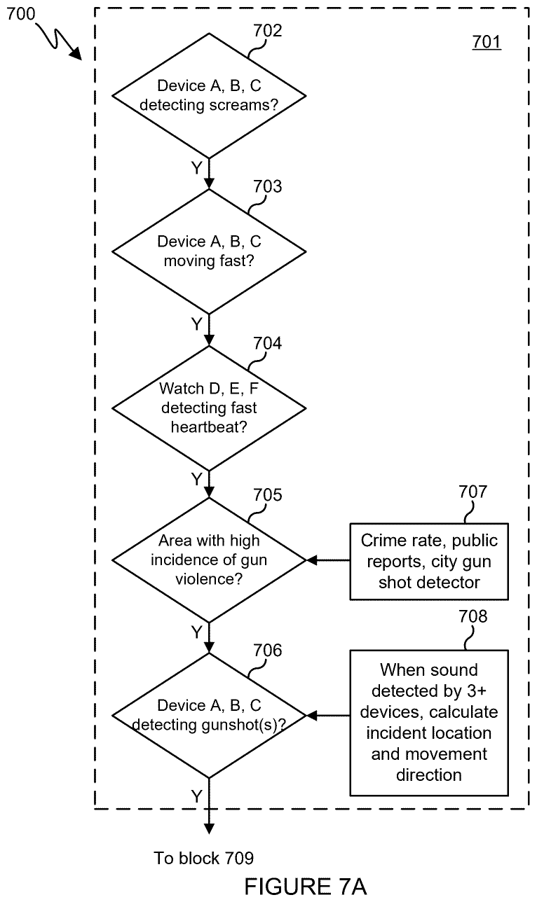

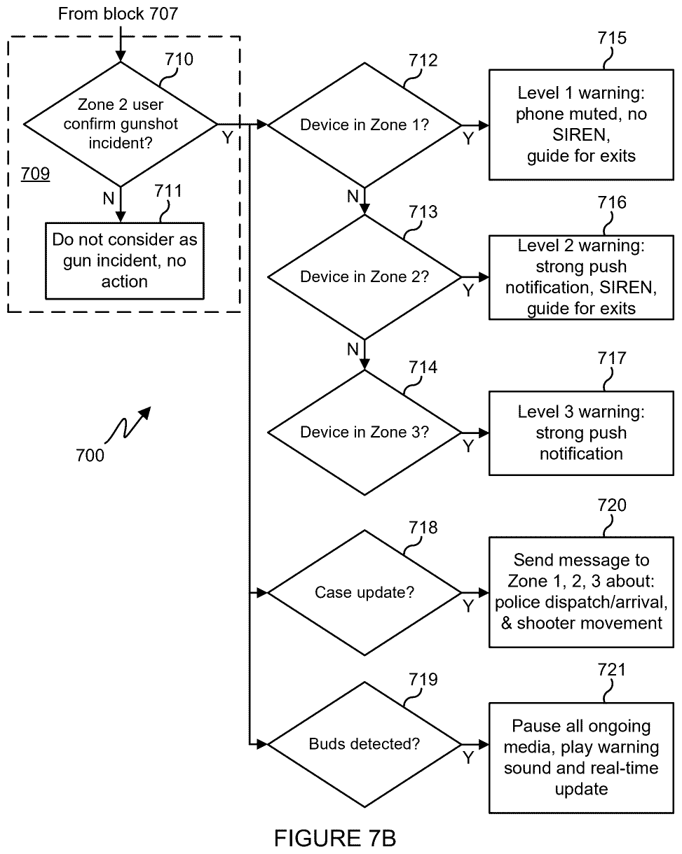

FIGS. 7A and 7B illustrate another example process 700 for detecting emergency incidents and providing differential alerts in accordance with this disclosure. For case of explanation, the process 700 is described as involving the use of the electronic device 101 in the network configuration 100 of FIGS. 7A and 7B. However, the process 700 may be used with any other suitable electronic device(s), such as the server 106, and in any other suitable system(s).

The process 700 includes a set 701 of steps for identifying gunshots or other incidents with boosted accuracy. Portions of the set 701 of steps are performed using a plurality of smart devices (such as electronic devices 101, 102, and 104) within the area of the potential emergency situation, while other portions are performed by a server (such as server 106). Within the set 701 of steps, an initial determination 702 is made of whether a plurality of devices (identified as “A,” “B,” and “C” for purposes of describing process 700) detect screams or other specified sounds. The set 701 of steps also includes a determination 703 of whether at least some of the plurality of devices are moving fast, suggestive that the users are running. The set 701 of steps further includes a determination 704 of whether at least some of a plurality of wearable devices (identified as “D,” “E,” and “F” for purposes of describing process 700) detect elevated heartbeat rates. The set 701 of steps still further includes a determination 705 of whether an area within which the plurality of device and the plurality of wearable devices are located has a high incidence of gun violence and a determination 706 of whether any of the plurality of devices detects gunshots. The determination 705 may rely on inputs 707 regarding crime rate, public reports of an emergency situation, and/or signals from a city gunshot detector. The determination 708 may rely on multiple inputs 708 from the plurality of devices for a determination of whether gunshots were detected by a specified number (such as three or more) devices in order to calculate the incident location and direction of movement, if any. While FIG. 7A depicts determinations 702, 703, 704, 705, and 706 are being performed serially, those skilled in the art will recognize that those determinations may be made in parallel or in a different order and the results collated. In addition, other inputs may be utilized in identifying whether an incident is occurring, such as video from smart glasses.

From the set 701 of steps, the process 700 proceeds to a set 709 of steps for human confirmation of the incident. As discussed above, zones are assigned and requests for confirmation of the incident are sent to devices within Zone 2, since asking users of devices within Zone 1 to manually confirm the incident may be unsafe for those users. If a sufficient number of Zone 2 users negate confirmation of the incident and/or a predetermined period elapses without confirmation, the potential emergency situation is not considered (block 711) as an emergency incident, and no further action is taken.

Otherwise, determinations 712, 713, and 714 are made for each device identified as within a predetermined distance (such as less than X+Y+Z meters away) of the incident. The determination 712 is made of whether the respective device is within Zone 1. If so, a Level 1 warning is sent 715 to that device for which the sound may be muted and no siren sound may be output, and a guide for exits from the area may be provided. The determination 713 is made whether the respective device is within Zone 2. If so, a Level 2 warning (such as a strong push notification) is sent 716 to that device for which a siren sound may be output, and a guide for exits from the area may be provided. The determination 714 is made whether the respective device is within Zone 3. If so, a Level 3 warning is sent 717 to that device, which may be a strong push notification.

In parallel with the determinations 712, 713, and 714, determinations 718 and 719 may also be made. The determination 718 is made whether the status of the incident should be updated and may be performed periodically or at other times. If so, a message is sent 720 to devices in Zones 1, 2, and 3 about either or both of police dispatch/arrival and incident location movement. The determination 719 is made for each device whether ear buds are detected as connected to the respective device. If so, all ongoing media is paused 721, and a warning sound and real-time updates are played.

Although FIGS. 7A and 7B illustrate another example of a process 700 for detecting emergency incidents and providing differential alerts, various changes may be made to FIGS. 7A and 7B. For example, while shown as a series of steps, various steps in FIGS. 7A and 7B could overlap, occur in parallel, occur in a different order, or occur any number of times (including zero times).

In the present disclosure, when Zone 1 devices detect potential gunshots or other incidents, users of Zone 2 devices may receive an alert to confirm the emergency incident to increase the accuracy of incident detection. If not enough Zone 2 owners confirm the incident, the incident may not be confirmed as an emergency situation. Alerts sent to Zone 1 devices may be silent, minimizing user interaction due to safety concerns. Once the incident is confirmed, differential alerts may be provided by dividing devices in different zone ranges (such as Zones 1-3), including very close proximity (the same space as the incident location), close proximity (such as the same building), and surrounding areas. In Zone 1, an alert may only be provided on-screen in very close areas, and no sound/vibration may be provided. In Zone 2, more detailed evacuation guidance may be provided than for Zone 1, together with a sound/haptic occurrence. In Zone 3, a sound/haptic/visual alert may be provided and automatically reported to 911 for identified situations. Based on the location of the incident, the zone settings can be defined differently.

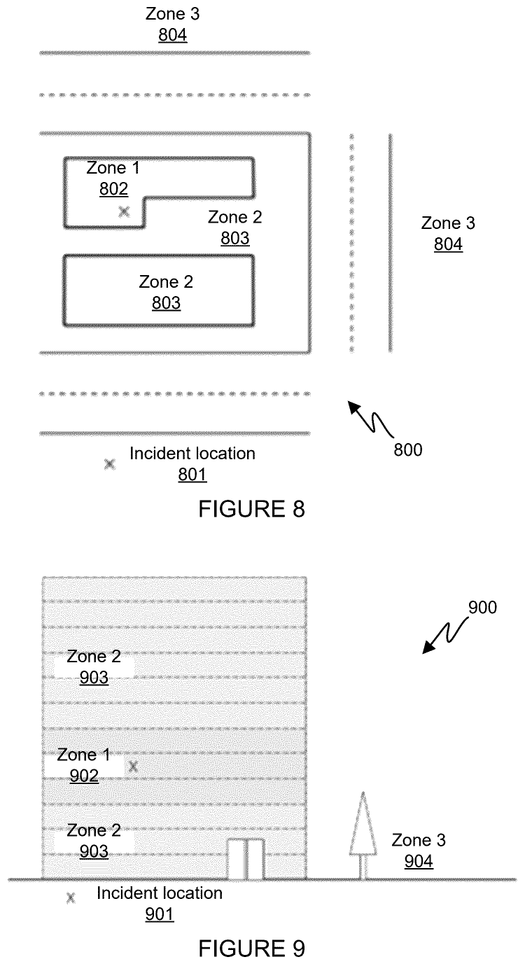

FIG. 8 illustrates another example distance-based assignment 800 of zones in accordance with this disclosure. In this example, an incident is assumed to occur within a single-story building. Building structures and other terrain features may be taken into account when assigning zones. In the example of FIG. 8, the incident location 801 is identified to be inside a single-story building at the spot marked “x.” Zone 1 802 may be assigned to the entire building within which the incident is occurring. Zone 2 803 may be assigned to locations outside in the parking lot and/or in adjacent buildings. Zone 3 804 may be assigned to locations across the street from the building in which the incident is occurring.

FIG. 9 illustrates yet another example distance-based assignment 900 of zones in accordance with this disclosure. In this example, an incident is assumed to occur within a multi-story building. In the example of FIG. 9, the incident location 901 is identified to be inside a multi-story building on the floor marked “x.” Zone 1 902 may be assigned to the floor on which incident is occurring and adjacent floors. Zone 2 903 may be assigned to remaining floors within the same building. Zone 3 904 may be assigned to locations outside the building.

Although FIGS. 8 and 9 illustrate other examples of distance-based assignments of zones, various changes may be made to FIGS. 8 and 9. For example, zones may be assigned in any other suitable manner.

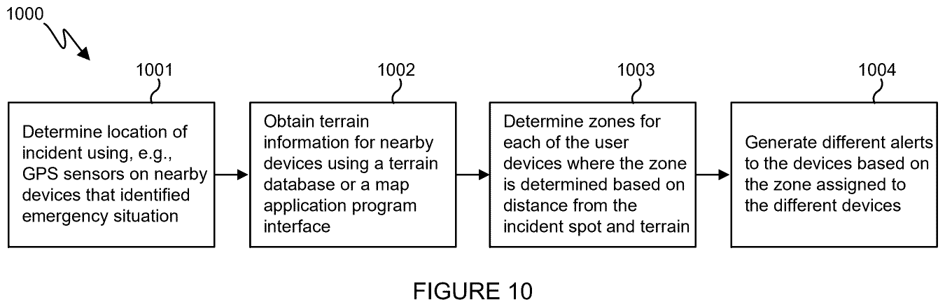

FIG. 10 illustrates an example process 1000 for zone assignment for differential alerts depending on terrain in accordance with this disclosure. For case of explanation, the process 1000 is described as involving the use of the electronic device 101 in the network configuration 100 of FIG. 1. However, the process 1000 may be used with any other suitable electronic device(s), such as the server 106, and in any other suitable system(s).

The process 1000 includes determining a location of an incident using, for example, GPS sensors on nearby devices that identified emergency situation (block 1001). Terrain information for locations near the devices is obtained (block 1002), such as by using a terrain database or a map application program interface (API). Zones are determined and assigned to each of the user devices (block 1003), where the zones are determined based on distance from the incident spot, terrain of the incident location, terrain at which the devices are located, etc. Different alerts to the devices are generated (block 1004) based on the zone assigned to the different devices.

Although FIG. 10 illustrates one example of a process 1000 for zone assignment for differential alerts depending on terrain, various changes may be made to FIG. 10. For example, while shown as a series of steps, various steps in FIG. 10 could overlap, occur in parallel, occur in a different order, or occur any number of times (including zero times).

Regarding notifications to first responders and related incident updates, once an incident is confirmed as an emergency situation, the devices in Zone 3 may automatically call or otherwise report to 911 based on an established policy. In some cases, this may occur using collected data and locations from nearby devices. After the 911 contact is initiated, when the case is updated, messages can be sent to the user devices in different zones about the latest evacuation guidance or police/emergency response alerts.

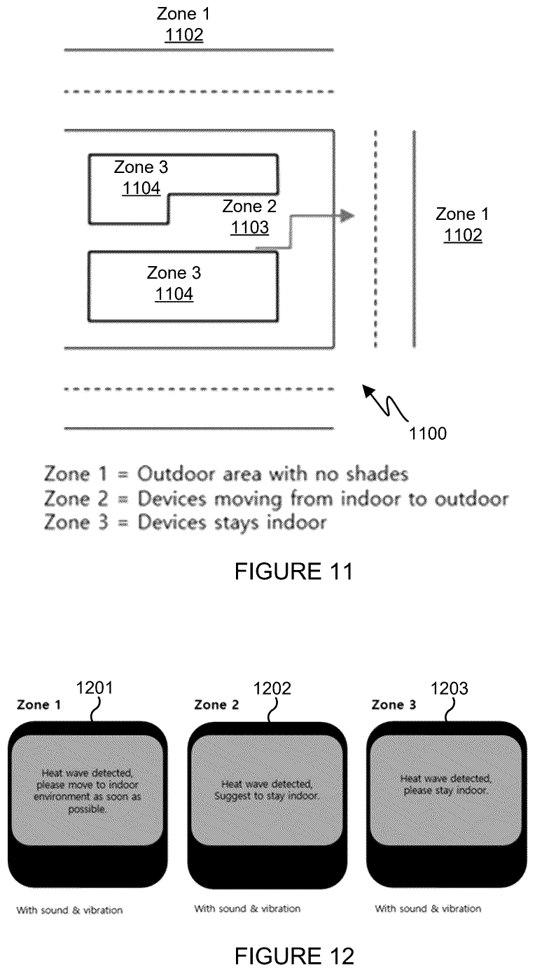

Note that the techniques described in the present disclosure can also be applied to other types of emergency situations, such as heat wave warnings, earthquakes, or tsunamis. When that type of emergency is detected or announced by authorities, the determination of the zone number can change accordingly. For example, in heatwave cases, zones can be divided by indoor versus outdoor or above ground versus in a subway. FIG. 11 illustrates an example assignment 1100 of zones for a heatwave incident in accordance with this disclosure. In this example, Zone 1 1102 may be assigned to outdoor areas with no shade. Zone 2 1103 may be assigned to locations through which devices must pass in moving from indoors to outdoors. Zone 3 1104 may be assigned to locations where devices are indoor.

For these types of situations, alarms sent to devices may also be different. For example, since there is no suspect in this case, devices in Zone 1 (being the most urgent group) can receive push notifications with sound and vibration so that the device owners can be aware of the situation. FIG. 12 depicts an example of different notifications for different zone assignments with respect to FIG. 11 in accordance with this disclosure. In this example, devices located within Zone 1 1102 can be sent an alert 601 with sound/haptic output that may read “Heat wave detected, please move to indoor environment as soon as possible.” Devices within Zone 2 1103 can be provided an alert 1202 that may read “Heat wave detected, suggest staying indoors.” Devices located within Zone 3 1104 can be provided an alert that may read “Heat wave detected, please stay indoors.”

Although FIGS. 11 and 12 illustrate one example of an assignment of zones for a heatwave incident and related details, various changes may be made to FIGS. 11 and 12. For example, the specific zones and alerts shown in FIGS. 11 and 12 are examples only and can easily vary depending on the circumstances.

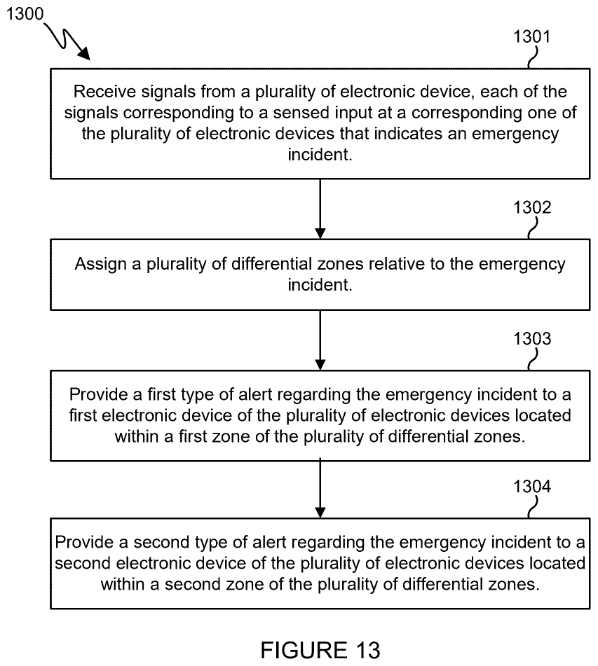

FIG. 13 illustrates an example method 1300 for emergency incident detection using multiple devices and differential alerting to nearby devices in accordance with this disclosure. For case of explanation, the method 1300 is described as involving the use of the electronic device 101 in the network configuration 100 of FIG. 1. However, the method 1300 may be used with any other suitable electronic device(s), such as the server 106, and in any other suitable system(s).

As shown in FIG. 13, the method 1300 includes receiving signals from a plurality of electronic devices (step 1301). Each received signal corresponds to a sensed input at a corresponding one of the electronic devices that indicates an emergency incident (such as a gunshot sound). Multiple differential zones relative to the emergency incident are assigned (step 1302). Locations within a second zone are more distant (such as farther away, on a different floor, or otherwise separated by a barrier that requires farther travel) from the emergency incident than locations within a first zone.

A first type of alert regarding the emergency incident is provided (step 1303) to a first of the electronic devices located within the first zone of the multiple differential zones. A second type of alert regarding the emergency incident is provided (step 1304) to a second of the plurality of electronic devices located within the second zone of the multiple differential zones. The second type of alert is different from the first type of alert, such as in terms of associated sounds and/or haptics.

Although FIG. 13 illustrates one example of a method 1300 for emergency incident detection using multiple devices and differential alerting to nearby devices, various changes may be made to FIG. 13. For example, while shown as a series of steps, various steps in FIG. 13 could overlap, occur in parallel, occur in a different order, or occur any number of times (including zero times).

It should be noted that the functions shown in the figures or described above can be implemented in an electronic device 101, 102, 104, server 106, or other device(s) in any suitable manner. For example, in some embodiments, at least some of the functions shown in the figures or described above can be implemented or supported using one or more software applications or other software instructions that are executed by the processor 120 of the electronic device 101, 102, 104, server 106, or other device(s). In other embodiments, at least some of the functions shown in the figures or described above can be implemented or supported using dedicated hardware components. In general, the functions shown in the figures or described above can be performed using any suitable hardware or any suitable combination of hardware and software/firmware instructions. Also, the functions shown in the figures or described above can be performed by a single device or by multiple devices.

Although this disclosure has been described with reference to various example embodiments, various changes and modifications may be suggested to one skilled in the art. It is intended that this disclosure encompass such changes and modifications as fall within the scope of the appended claims.

What is claimed is:

1. A method comprising:
receiving signals from a plurality of electronic devices, each of the signals corresponding to a sensed input at a corresponding one of the plurality of electronic devices that indicates an emergency incident;
assigning a plurality of differential zones relative to the emergency incident;
providing a first type of alert regarding the emergency incident to a first electronic device of the plurality of electronic devices located within a first zone of the plurality of different zones; and
providing a second type of alert regarding the emergency incident to a second electronic device of the plurality of electronic devices located within a second zone of the plurality of different zones;
wherein locations within the second zone are more distant from the emergency incident than locations within the first zone; and
wherein the first type of alert differs from the second type of alert.

2. The method of claim 1, wherein:
the second type of alert solicits user confirmation of the emergency incident and includes both sound and vibration; and
the first type of alert does not include a prompt for user input and includes no sound and no vibration.

3. The method of claim 1, wherein:
the plurality of different zones comprises the first zone, the second zone, and a third zone;
locations within the third zone are more distant from the emergency incident than locations within the second zone;
the method further comprises providing a third type of alert regarding the emergency incident to a third electronic device of the plurality of electronic devices located within the third zone;
the first type of alert includes no sound, no vibration, and first emergency response information; and
the second and third types of alerts include both sound and vibration and emergency response information different from the first emergency response information.

4. The method of claim 1, wherein:
the sensed input includes audio indicating a gunshot; and
each of the received signals includes a first signal corresponding to detection of the gunshot and location information for the respective one of the plurality of electronic devices.

5. The method of claim 4, wherein the sensed input indicates movement of the respective electronic device and, when the respective electronic device is a wearable device, biometric data for a user wearing the respective electronic device.

6. The method of claim 1, further comprising, after receiving the signals from the plurality of electronic devices and before providing the first type of alert and the second type of alert, at least one of:
determining a likelihood of existence of the emergency incident; or
requesting manual confirmation of the emergency incident by a user of either the second electronic device or any other electronic device located within the second zone of the plurality of different zones.

7. The method of claim 6, wherein the likelihood of existence of the emergency incident is determined based on at least one of:
audio at one or more of the plurality of electronic devices indicating screaming;
crime rate statistics for an area of the emergency incident;
at least one emergency call from the area of the incident; or
social media information.

8. An electronic device comprising:
at least one processing device configured to:
receive signals from a plurality of electronic devices, each of the signals corresponding to a sensed input at a corresponding one of the plurality of electronic devices that indicates an emergency incident; and
assign a plurality of different zones relative to the emergency incident; and
a transceiver configured to:
provide a first type of alert regarding the emergency incident to a first electronic device of the plurality of electronic devices located within a first zone of the plurality of different zones; and
provide a second type of alert regarding the emergency incident to a second electronic device of the plurality of electronic devices located within a second zone of the plurality of different zones;
wherein locations within the second zone are more distant from the emergency incident than locations within the first zone; and
wherein the first type of alert differs from the second type of alert.

9. The electronic device of claim 8, wherein:
the second type of alert solicits user confirmation of the emergency incident and includes both sound and vibration; and
the first type of alert does not include a prompt for user input and includes no sound and no vibration.

10. The electronic device of claim 8, wherein:
the plurality of different zones comprises the first zone, the second zone, and a third zone;
locations within the third zone are more distant from the emergency incident than locations within the second zone;
the transceiver is further configured to provide a third type of alert regarding the emergency incident to a third electronic device of the plurality of electronic devices located within the third zone;
the first type of alert includes no sound, no vibration, and first emergency response information; and
the second and third types of alerts include both sound and vibration and emergency response information different from the first emergency response information.

11. The electronic device of claim 8, wherein:
the sensed input includes audio indicating a gunshot; and
each of the received signals includes a first signal corresponding to detection of the gunshot and location information for the respective one of the plurality of electronic devices.

12. The electronic device of claim 11, wherein the sensed input indicates movement of the respective electronic device and, when the respective electronic device is a wearable device, biometric data for a user wearing the respective electronic device.

13. The electronic device of claim 8, wherein the at least one processing device is further configured, after receiving the signals from the plurality of electronic devices and before providing the first type of alert and the second type of alert, to at least one of:
determine a likelihood of existence of the emergency incident; or
request manual confirmation of the emergency incident by a user of either the second electronic device or any other electronic device located within the second zone of the plurality of different zones.

14. The electronic device of claim 13, wherein the at least one processing device is configured to determine the likelihood of existence of the emergency incident based on at least one of:
audio at one or more of the plurality of electronic devices indicating screaming;
crime rate statistics for an area of the emergency incident;
at least one emergency call from the area of the incident; or
social media information.

15. A non-transitory machine readable medium containing instructions that when executed cause at least one processor of an electronic device to:
receive signals from a plurality of electronic devices, each of the signals corresponding to a sensed input at a corresponding one of the plurality of electronic devices that indicates an emergency incident;
assign a plurality of different zones relative to the emergency incident;
provide a first type of alert regarding the emergency incident to a first electronic device of the plurality of electronic devices located within a first zone of the plurality of different zones; and
provide a second type of alert regarding the emergency incident to a second electronic device of the plurality of electronic devices located within a second zone of the plurality of different zones;
wherein locations within the second zone are more distant from the emergency incident than locations within the first zone; and
wherein the first type of alert differs from the second type of alert.

16. The non-transitory machine readable medium of claim 15, wherein:
the second type of alert solicits user confirmation of the emergency incident and includes both sound and vibration; and
the first type of alert does not include a prompt for user input and includes no sound and no vibration.

17. The non-transitory machine readable medium of claim 15, wherein:
the plurality of different zones comprises the first zone, the second zone, and a third zone;
locations within the third zone are more distant from the emergency incident than locations within the second zone;
the non-transitory machine readable medium further contains instructions that when executed cause the at least one processor to provide a third type of alert regarding the emergency incident to a third electronic device of the plurality of electronic devices located within the third zone;
the first type of alert includes no sound, no vibration, and first emergency response information; and
the second and third types of alerts include both sound and vibration and emergency response information different from the first emergency response information.

18. The non-transitory machine readable medium of claim 15, wherein:
the sensed input includes audio indicating a gunshot; and
each of the received signals includes a first signal corresponding to detection of the gunshot and location information for the respective one of the plurality of electronic devices.

19. The non-transitory machine readable medium of claim 18, wherein the sensed input indicates movement of the respective electronic device and, when the respective electronic device is a watch or ear buds, biometric data for a user wearing the respective electronic device.

20. The non-transitory machine readable medium of claim 15, further containing instructions that when executed cause the at least one processor, after receiving the signals from the plurality of electronic devices and before providing the first type of alert and the second type of alert, to at least one of:
determine a likelihood of existence of the emergency incident; or
request manual confirmation of the emergency incident by a user of either the second electronic device or any other electronic device located within the second zone of the plurality of different zones.
